(19) United States
(12) Patent Application Publication
(10) Pub. No.: US 2023/0059674 A1
(43) Pub. Date: Feb. 23, 2023

(54) DISTRIBUTED LEARNING SERVER AND DISTRIBUTED LEARNING METHOD

(71) Applicant: SAMSUNG ELECTRONICS CO., LTD., Suwon-si (KR)

(72) Inventors: Taejeoung KIM, Suwon-si (KR); Kyunam CHO, Suwon-si (KR)

(21) Appl. No.: 17/735,352

(22) Filed: May 3, 2022

Related U.S. Application Data
(63) Continuation of application No. PCT/KR2022/004806, filed on Apr. 4, 2022.

(30) Foreign Application Priority Data
Aug. 17, 2021 (KR) 10-2021-0108177

(51) Int. Cl. G06N 20/20; G06N 5/04

(52) U.S. Cl. CPC G06N 20/20; G06N 5/043

(57) ABSTRACT

Provided is a method, performed by a server, of performing distributed learning. The server builds a computer cluster by selecting worker nodes that are to perform distributed learning, from among a plurality of nodes, wherein nodes in the computer cluster include the server that is a master node and the worker nodes. The server identifies, with respect to each of the nodes in the computer cluster, an operation time taken for each of the nodes in the computer cluster to perform training, and adjusts a number of data included in each of data subsets, based on the operation time of each of the nodes in the computer cluster, the data subsets being used in training of the nodes in the computer cluster.

### CROSS-REFERENCE TO RELATED APPLICATIONS

This application is a continuation of International Application No. PCT/KR2022/004806 designating the United States, filed on Apr. 4, 2022, in the Korean Intellectual Property Receiving Office and claiming priority to Korean Patent Application No. 10-2021-0108177, filed on Aug. 17, 2021, in the Korean Intellectual Property Office, the disclosures of which are incorporated by reference herein in their entireties.

### BACKGROUND

### Field

The disclosure relates to a distributed learning server and a distributed learning method for performing distributed learning by using a plurality of nodes in a computer cluster.

### Description of Related Art

As a method of training an artificial intelligence (AI) model, distributed learning, in which an AI model is trained through distributed computing using a computer cluster, has been utilized. When distributed learning is performed using the computer cluster, a master node of the computer cluster may train the AI model by collecting training results from respective nodes. However, when acquisition of operation results processed from some nodes in the computer cluster is delayed due to a difference in the computing performance of nodes included in a cluster or a difference in a network speed, a delay may occur in the entire distributed learning process.

In relation to a method of performing distributed learning using a computer cluster, a method of improving a distributed learning speed by adjusting operation times of nodes in the computer cluster has been proposed.

### SUMMARY

Embodiments of the disclosure provide a distributed learning server and a distributed learning method for performing distributed learning using a plurality of nodes in a computer cluster.

According to an aspect of the disclosure, a method, performed by a server, of performing distributed learning includes: building a computer cluster by selecting worker nodes for performing distributed learning from among a plurality of nodes, wherein nodes in the computer cluster include the server comprising a master node and the worker nodes; determining data subsets by splitting a training dataset such that each of the data subsets corresponds to each of the nodes in the computer cluster; obtaining training results from the nodes in the computer cluster by training each artificial intelligence (AI) model stored in each of the nodes in the computer cluster based on each of the data subsets; updating weights of an AI model stored in the server based on the training results; identifying, with respect to each of the nodes in the computer cluster, an operation time taken for each of the nodes in the computer cluster to perform training; and; adjusting a number of data included in each of the data subsets, based on the operation time of each of the nodes in the computer cluster.

According to aspect of the disclosure, a server configured to perform distributed learning includes: a communication interface comprising communication circuitry; a memory storing one or more instructions; at least one processor configured to execute the one or more instructions stored in the memory; and the at least one processor is further configured based on executing the one or more instructions to: build a computer cluster by selecting worker nodes configured to perform distributed learning from among a plurality of nodes, wherein nodes in the computer cluster include the server comprising a master node and the worker nodes; determine data subsets by splitting a training dataset such that each of the data subsets corresponds to each of the nodes in the computer cluster; obtain training results from the nodes in the computer cluster by training each artificial intelligence (AI) model stored in each of the nodes in the computer cluster based on each of the data subsets; update weights of an AI model stored in the server based on the training results; identify, with respect to each of the nodes in the computer cluster, an operation time taken for each of the nodes in the computer cluster to perform training; and adjust a number of data included in each of the data subsets, based on the operation time of each of the nodes in the computer cluster.

According to aspect of the disclosure, a non-transitory computer-readable recording medium storing a program for performing the method is provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating a computer cluster that uses a server as a master node according to an embodiment of the disclosure.

FIG. 2 is a flowchart illustrating a method, performed by a server, of building a computer cluster and performing distributed learning according to an embodiment of the disclosure.

FIG. 3 is a diagram illustrating a method, performed by a server, of selecting worker nodes from among a plurality of nodes and building a computer cluster according to an embodiment of the disclosure.

FIG. 4 is a diagram illustrating a method, performed by a server, of determining data subsets by splitting a training dataset according to an embodiment of the disclosure.

FIG. 5 is a diagram illustrating a data configuration of a data subset according to an embodiment of the disclosure.

FIG. 6 is a diagram illustrating that nodes in a computer cluster perform distributed learning using data subsets according to an embodiment of the disclosure.

FIG. 7 is a flowchart illustrating a method, performed by a server, of operating a computer cluster and performing distributed learning according to an embodiment of the disclosure.

FIG. 8 is a diagram illustrating a method, performed by a server, of adjusting the number of data batches included in each of data subsets according to an embodiment of the disclosure as an epoch which is a part of a distributed learning process is performed.

FIG. 9 is a diagram further illustrating FIG. 8 to illustrate execution of epochs 1 and 2 by nodes in a computer cluster which are part of a distributed learning process.

FIG. 10 is a diagram further illustrating FIG. 8 to illustrate execution of epochs 1 to 4 by a first worker node which is part of a distributed learning process.

FIG. 11 is a diagram illustrating another method, performed by a server, of adjusting the number of data batches included in each of data subsets according to an embodiment of the disclosure as an epoch which is a part of a distributed learning process is performed.

FIG. 12 is a diagram illustrating another method, performed by a server, of splitting a training data set and determining data subsets according to an embodiment of the disclosure.

FIG. 13 is a flowchart illustrating another method, performed by a server, of operating a computer cluster and performing distributed learning according to an embodiment of the disclosure.

FIG. 14 is a block diagram illustrating a configuration of a server according to an embodiment of the disclosure.

### DETAILED DESCRIPTION

Throughout the disclosure, the expression “at least one of a, b or c” indicates only a, only b, only c, both a and b, both a and c, both b and c, all of a, b, and c, or variations thereof.

The terms used in the disclosure will be briefly described, and the disclosure will be described in greater detail.

All terms including descriptive or technical terms which are used herein should be construed as having meanings apparent to one of ordinary skill in the art. However, the terms may have different meanings according to the intention of one the disclosure, precedent cases, or the appearance of new technologies. Also, some terms may be arbitrarily selected, and in this case, the meaning of such terms will be described in detail in the detailed description of the disclosure. Thus, the terms used herein are to be understood based on the meaning of the terms together with the description throughout the disclosure.

An expression used in the singular may encompass the expression in the plural, unless it has a clearly different meaning in the context. Terms used herein, including technical or scientific terms, may have the same meaning as commonly understood by one of ordinary skill in the art described in the disclosure. Terms such as “first” and “second” used herein may be used to describe various elements but the elements should not be limited by the terms. These terms are only used to distinguish one element from another element.

When a part “includes” or “comprises” an element, unless there is a particular description contrary thereto, the part may further include other elements, not excluding the other elements. In addition, terms such as “unit” and “module” described in the disclosure denote a unit that processes at least one function or operation, which may be implemented in hardware or software, or implemented in a combination of hardware and software.

Hereinafter, embodiments of the disclosure will be described in greater detail with reference to the accompanying drawings. However, the disclosure may be implemented in various different forms and is not limited to the example embodiments of the disclosure described herein. Also, in the drawings, parts irrelevant to the description may be omitted in order to clearly describe the disclosure, and like reference numerals designate like elements throughout the disclosure.

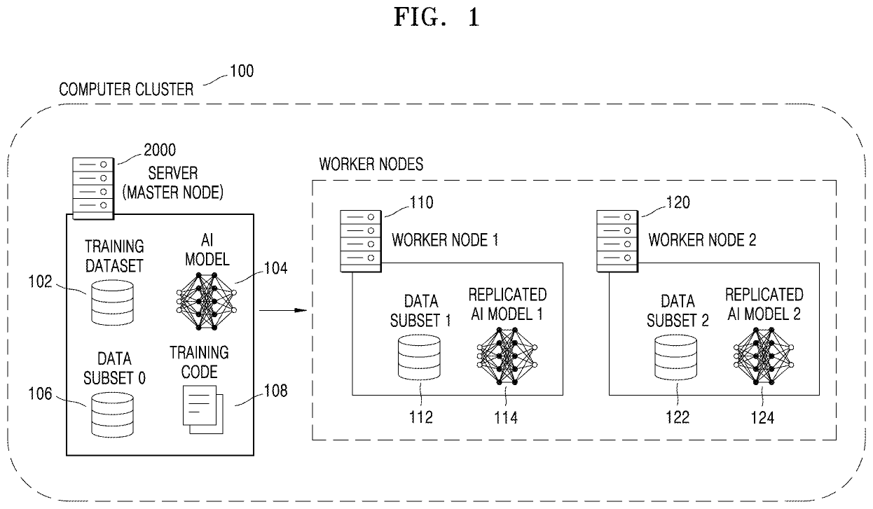

FIG. 1 is a diagram illustrating a computer cluster that uses a server 2000 as a master node according to an embodiment of the disclosure.

In the disclosed embodiment of the disclosure, the computer cluster 100 refers to a set of server nodes (hereinafter, nodes) in which several computers are connected and work together so that they can be viewed as a single system. The computer cluster 100 includes the server 2000 that is the master node and worker nodes that provide processing resources. The server 2000 according to an embodiment of the disclosure may distribute data to the worker nodes as the master node and manage data throughput.

The server 2000 may perform distributed learning of an artificial intelligence (AI) model 104 stored in the server 2000 using the server 2000 and the worker nodes in the computer cluster 100. The server 2000 may train the AI model 104 based on a training dataset 102. The server 2000 may perform distributed learning using a data parallelism method.

In an embodiment of the disclosure, the computer cluster 100 may include the server 2000 that is the master node, a worker node 1 110, and a worker node 2 120. In order to perform distributed learning of the AI model 104, the server 2000 may copy the AI model 104 to generate a replicated AI model. For example, the server 2000 may copy the AI model 104 to provide a replicated AI model 1 114 to the worker node 1 110, and provide a replicated AI model 2 124 to the worker node 2 120.

In an embodiment of the disclosure, the server 2000 may split the training dataset 102 so as to perform distributed learning. For example, the server 2000 may split the training dataset 102 into a data subset 0 106, a data subset 1 112, and a data subset 2 122. The server 2000 may provide the data subset 1 112 to the worker node 1 110 and provide the data subset 2 122 to the worker node 2 122. The data subset 0 106 may be used by the server 2000 to train the AI model 104 stored in the server 2000.

In an embodiment of the disclosure, the server 2000 may execute a training code 108 so that AI models stored in the server 2000, the worker node 1 110 and the worker node 2 120 may be independently trained in the server 2000, the worker node 1 110 and the worker node 2 120, respectively. For example, the server 2000 may train the AI model 104 based on the data subset 0 106, the worker node 1 110 may train the replicated AI model 1 114 based on the data subset 1 112, and the worker node 2 120 may train the replicated AI model 2 124 based on the data subset 2 122.

The server 2000 may obtain a training result of the server 2000 and training results of the worker nodes 1 110 and 2 120 to update weights of the AI model 104 stored in the server 2000. In addition, the server 2000 may synchronize the updated AI model 104 with the replicated AI model 1 114 and the replicated AI model 2 124 to update the replicated AI model 1 114 and the replicated AI model 2 124.

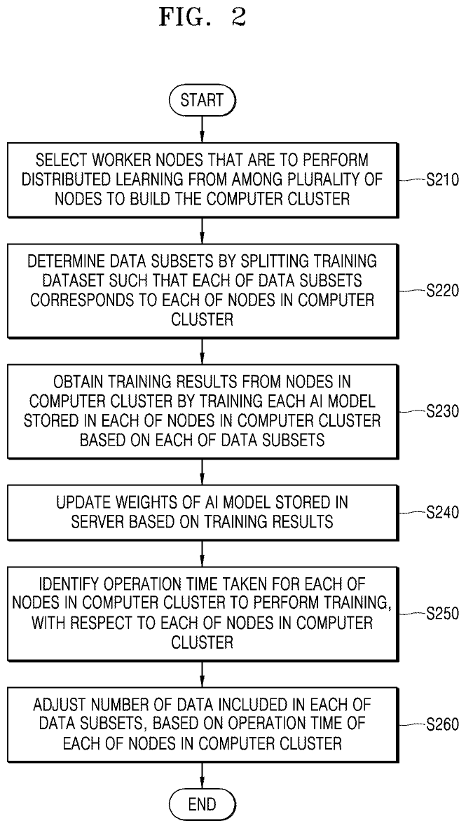

FIG. 2 is a flowchart illustrating a method, performed by the server 2000, of building a computer cluster and performing distributed learning according to an embodiment of the disclosure.

In operation S210, the server 2000 according to an embodiment of the disclosure may select worker nodes that are to perform distributed learning from among a plurality of nodes to build the computer cluster. The server 2000 may perform distributed learning of an AI model using a data parallelism method according to embodiments of the disclosure to be described later.

In an embodiment of the disclosure, the server 2000 may identify nodes available for distributed learning among the plurality of nodes. An available node may be an idle node that is not performing another work, or a node with free computing resources capable of performing distributed learning. The server 2000 may select worker nodes that are to perform distributed learning from among the available nodes to build the computer cluster. For example, the server 2000 may select all of the available nodes to build the computer cluster. The server 2000 may select some of the available nodes to build the computer cluster.

In an embodiment of the disclosure, the server 2000 operates as a master node of the computer cluster. The server 2000 may control other worker nodes included in the computer cluster or may transmit a work command to the other worker nodes included in the computer cluster.

In operation S220, the server 2000 according to an embodiment of the disclosure may determine data subsets by splitting a training dataset so that each of the data subsets corresponds to each of nodes in the computer cluster.

In an embodiment of the disclosure, the server 2000 may determine the data subsets based on the number of nodes in the computer cluster. The server 2000 may split the training dataset to determine a plurality of data subsets, based on the master node and the number of worker nodes. In this case, one data subset may correspond to one node.

The server 2000 may index training data in the training dataset and allow the data subsets to be distinguished based on index numbers to determine the data subsets. For example, a first data subset may include training data of index numbers 1 to 25, and a second data subset may include training data of index numbers 26 to 50. A plurality of pieces of data may have the same index number. For example, the plurality of pieces of data having the same index number may refer, for example, to the server 2000 indexing a plurality of pieces of training data as the same index number based on a batch size. The server 2000 may index the plurality of pieces of training data as the same index number based on a batch, which is a group of data, and is a unit input when a node trains an AI model. For example, when the batch size is 10, the server 2000 may index 10 training data in the training dataset as index number 1, and index 10 other training data in the training dataset as index number 2.

As in the above example, because the first data subset includes training data of index numbers 1 to 25, and there are 10 training data for each index number, the first data subset may include a total of 250 pieces of training data.

In operation S230, the server 2000 according to an embodiment of the disclosure may train each AI model stored in each of the nodes in the computer cluster based on each of the data subsets to obtain training results from the nodes in the computer cluster.

In an embodiment of the disclosure, the server 2000 may copy the AI model stored in the server 2000 to transfer replicated AI models to the worker nodes. The server 2000 may execute a training code for performing distributed learning so that the nodes in the computer cluster may train the AI models stored in the nodes. The server 2000 may obtain the training results from the nodes in the computer cluster.

For example, the server 2000 may obtain a first training result generated by allowing a first worker node among the worker nodes to train an AI model stored in the first worker node using a first data subset, from the first worker node. In addition, the server 2000 may obtain a second training result generated by allowing a second worker node among the worker nodes to train an AI model stored in the second worker node using a second data subset, from the second worker node. In addition, because the server 2000 also performs distributed learning as the master node, the server 2000 may obtain a training result of the master node generated by training the AI model stored in the server 2000 using a data subset corresponding to the server 2000.

In operation S240, the server 2000 according to an embodiment of the disclosure may update weights of the AI model stored in the server 2000 based on the training results.

The server 2000 may update the weights of the AI model stored in the server 2000, based on gradients obtained by the nodes in the computer cluster through operations. The server 2000 may synchronize the AI model stored in the server 2000 and the AI models stored in the worker nodes.

In operation S250, the server 2000 according to an embodiment of the disclosure may identify an operation time taken for each of the nodes in the computer cluster to perform training, with respect to each of the nodes in the computer cluster.

In an embodiment of the disclosure, the nodes in the computer cluster may have different training speeds. As described above in operation S240, because the server 2000 obtain training results from the nodes in the cluster and updates the weights of the AI model stored in the server 2000, the server 2000 may update the AI model stored in the server 2000 after training of a node having the slowest training speed is completed. The server 2000 may identify the operation time taken for each of the nodes in the computer cluster to perform training, in order to reduce the number of training data of nodes having a training speed slower than that of other nodes by a certain reference or more among the nodes in the computer cluster.

In operation S260, the server 2000 according to an embodiment of the disclosure may adjust the number of data included in each of the data subsets, based on the operation time of each of the nodes in the computer cluster.

For example, when the operation time of the first worker node is shorter than the operation time of the second worker node by a certain reference or more, the server 2000 may adjust the number of data included in the first data subset of the first worker node and the number of data included in the second data subset of the second worker node. For example, as described above in operation S220, the first data subset may include training data of index numbers 1 to 25, and the second data subset may include training data of index numbers 26 to 50. The server 2000 may adjust the number of data between the data subsets so that the training data of index numbers 1 to 26 is included in the first data subset and the training data of index numbers 27 to 50 is included in the second data subset, and thus the first worker node may perform operation on more training data.

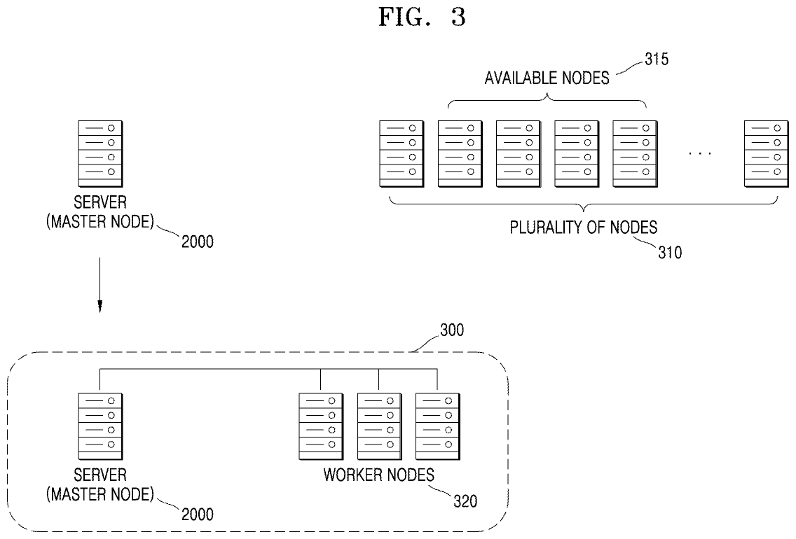

FIG. 3 is a diagram illustrating a method, performed by the server 2000, of selecting worker nodes from among a plurality of nodes 310 and building a computer cluster 300 according to an embodiment of the disclosure.

In an embodiment of the disclosure, the server 2000 may identify nodes 315 available for distributed learning among the plurality of nodes 310. An available node may be an idle node that is not performing another work, or a node with free computing resources capable of performing distributed learning. The server 2000 may identify the available nodes 315 and create a list of the available nodes 315. The server 2000 may identify an available node again according to whether each of the plurality of nodes 310 is performing a work, and update the list of available nodes 315.

In an embodiment of the disclosure, the server 2000 may select worker nodes 320 that are to perform distributed learning from among the available nodes 315. For example, the server 2000 may select all the available nodes 315 as the worker nodes 320. For another example, the server 2000 may select some of the available nodes 315 as the worker nodes 320. The server 2000 may select at least some of the worker nodes 320 from among the available nodes 315 to build the computer cluster 300 using the server 2000 as a master node. When the server 2000 builds the computer cluster 300, the selected worker nodes 320 may be excluded from the list of the available nodes 315. The server 2000 may remove at least some of the worker nodes 320 in the computer cluster 300 from the computer cluster 300, and incorporate at least some of the available nodes 315 into the computer cluster 300 as worker nodes, thereby rebuilding the computer cluster 300.

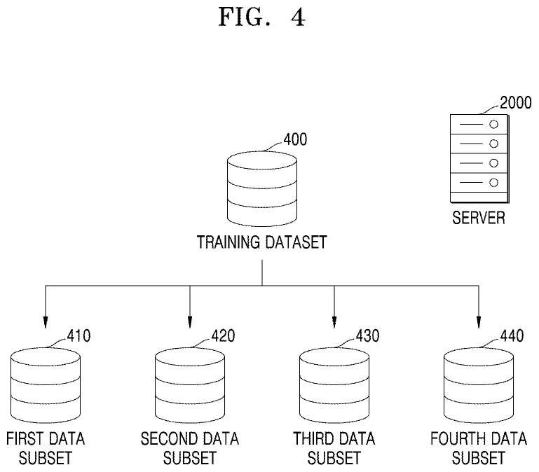

FIG. 4 is a diagram illustrating a method, performed by the server 2000, of determining first to fourth data subsets 410, 420, 430 and 440 (which may be referred to as data subsets 410 to 440) by splitting a training dataset 400 according to an embodiment of the disclosure.

In an embodiment of the disclosure, the server 2000 may split the training dataset 400 for training an AI model to determine a plurality of data subsets. The server 2000 may determine the number of data subsets to be generated by splitting the training dataset 400, based on the number of nodes in a computer cluster. For example, the server 2000 may generate data subsets to be as many as the number of nodes in the computer cluster.

Hereinafter, for convenience of explanation, a case in which the nodes in the computer cluster are a total of four nodes including the server 2000 that is a master node, a first worker node, a second worker node, and a third worker node will be described as an example. However, the number of nodes in the computer cluster is not limited thereto.

In an embodiment of the disclosure, the server 2000 may split the training dataset 400 to generate data subsets corresponding to the number of nodes in the computer cluster. For example, the server 2000 may split the training dataset 400 to generate the first data subset 410, the second data subset 420, the third data subset 430, and the fourth data subset 440.

In this case, each of the first to fourth data subsets 410 to 440 may correspond to each of the nodes in the computer cluster. For example, the first data subset 410 may correspond to the first worker node, the second data subset 420 may correspond to the second worker node, the third data subset 430 may correspond to the third worker node, and the fourth data subset 440 may correspond to the server 2000. Each of the nodes in the computer cluster may train an AI model stored in the node using the corresponding data subset.

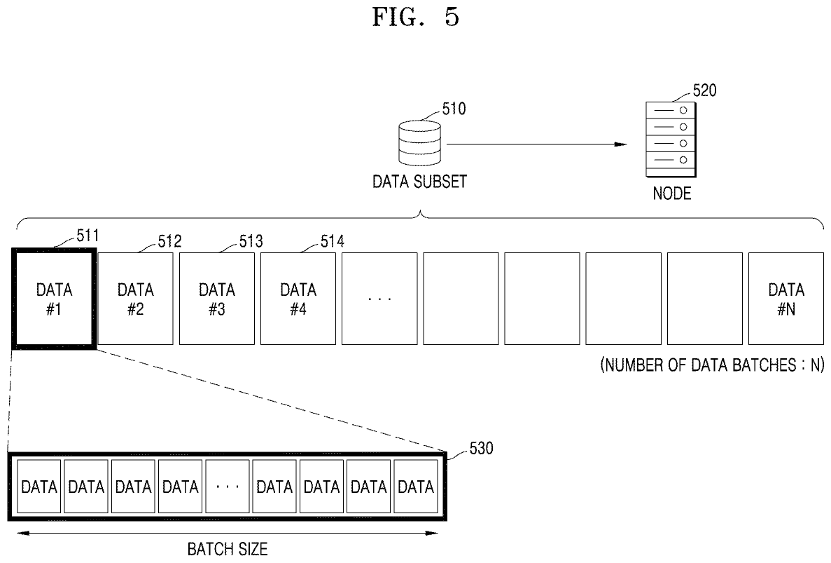

When the server 2000 splits the training dataset 400 to correspond to each of the nodes in the computer cluster, the server 2000 may index training data in the training dataset 400 and determine an index number to be included in each of first to fourth data subsets 410 to 440, thereby generating the first to fourth data subsets 410 to 440. An example in which the server 2000 distinguishes data subsets using an index of data will be further described in greater detail below with reference to FIG. 5.

FIG. 5 is a diagram illustrating a data configuration of a data subset 510 according to an embodiment of the disclosure.

Referring to FIG. 5, the server 2000 according to an embodiment of the disclosure may index training data in a training dataset and determine an index number to be included in each of the data subsets, thereby generating data subsets.

In an embodiment of the disclosure, the data subset 510 that is any one of a plurality of data subsets generated by the server 2000 may include N data batches. A data batch refers to a group of data, which is a unit of work input when a node trains an AI model. The data batches included in the data subset 510 may have an index number assigned by the server 2000.

The server 2000 may determine an index number to be included in the data subset 510. For example, the server 2000 may determine index numbers to be included in the data subset 510 as index numbers 1 to N to generate the data subset 510. In this case, the data subset 510 may include data #1 511 which is a data batch of index number 1, data #2 512 which is a data batch of index number 2, data #3 513 which is a data batch of index number 3, data #4 514 which is a data batch of index number 4, . . . , and data #N which is a data batch of index number N.

As in the above example, a plurality of pieces data may be included in one data batch and have the same index number. For example, a plurality of different of pieces data having the same index number may be included in one data batch. For example, the data #1 511 may include a plurality of pieces data 530. The number of the plurality of pieces of data 530 in a data batch may be referred to as a batch size.

In an embodiment of the disclosure, a node 520 (e.g., a master node or a worker node) in a computer cluster may train an AI model stored in the node 520, based on the data batches included in the data subset 510. The node 520 may perform an epoch that performs an operation on all training data in the data subset 510 and updates weights. The node 520 may input the data batch into the AI model stored in the node 520 to output loss. Referring to FIG. 5, because the number of data batches included in the data subset 510 is N, when the node 520 performs an operation on all training data in the data subset 510 by, N times, performing an iteration which is a process of performing an operation on each data batch and outputting loss, an epoch of training on the AI model stored in the node 520 may be performed one time.

When the server 2000 according to an embodiment of the disclosure adjusts the number of data batches of data subsets, the server 2000 may adjust only the number of data batches of data subsets while maintaining the batch size of data batches.

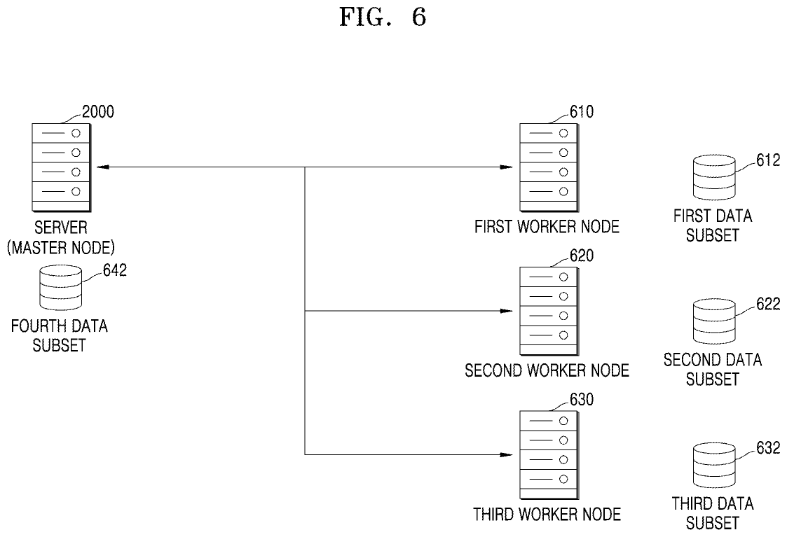

FIG. 6 is a diagram illustrating that nodes in a computer cluster perform distributed learning using data subsets according to an embodiment of the disclosure.

In FIG. 6, a case where the nodes in the computer cluster are a total of four nodes including the server 2000 that is a master node, a first worker node 610, a second worker node 620, and a third worker node 630 will be described as an example. However, the number of nodes in the computer cluster is not limited thereto.

In an embodiment of the disclosure, the server 2000 may split a training dataset such that each of the data subsets corresponds to each of the nodes in the computer cluster, thereby determining the data subsets. This has been described with reference to FIGS. 4 to 5, and thus repeated descriptions may be omitted.

In an embodiment of the disclosure, the server 2000 may execute a training code so that the server 2000 and worker nodes may perform distributed learning.

When the training code is executed, distributed learning of the AI model may be performed in the computer cluster including the server 2000 and the first to third worker nodes 610, 620, and 630.

When the server 2000 executes the training code, a training command may be transmitted from the server 2000 to the first worker node 610, and the first worker node 610 may train an AI model stored in the first worker node 610 using a first data subset 612. The server 2000 may obtain a first training result from the first worker node 610.

In addition, when the server 2000 executes the training code, the training command may be transmitted from the server 2000 to the second worker node 620, and the second worker node 620 may train an AI model stored in the second worker node 620 using a second data subset 622. The server 2000 may obtain a second training result from the second worker node 620.

In addition, when the server 2000 executes the training code, the training command may be transmitted from the server 2000 to the third worker node 630, and the third worker node 630 may train an AI model stored in the third worker node 630 using a third data subset 632. The server 2000 may obtain a third training result from the third worker node 630.

When the server 2000 executes the training code, the server 2000 may train the AI model stored in the server 2000 using a fourth data subset 642.

The server 2000 may collect the training result of the server 2000 and the first to third training results of the worker nodes 610, 620, and 630, and update weights of the AI model stored in the server 2000 based on the collected training results.

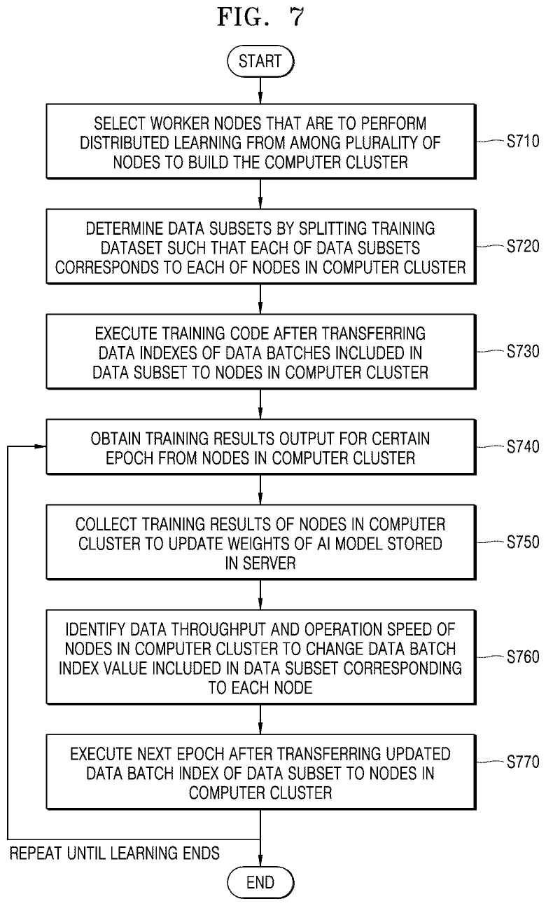

FIG. 7 is a flowchart illustrating a method, performed by the server 2000, of operating a computer cluster and performing distributed learning according to an embodiment of the disclosure.

In operation S710, the server 2000 according to an embodiment of the disclosure may select worker nodes that are to perform distributed learning from among a plurality of nodes to build the computer cluster. This corresponds to operation S210 of FIG. 2, and thus the same description may not be repeated here.

In operation S720, the server 2000 according to an embodiment of the disclosure may split a training dataset so that each of the data subsets corresponds to each of nodes in the computer cluster, thereby determining data subsets. This corresponds to operation S220 of FIG. 2, and thus the same description may not be repeated here.

In operation S730, the server 2000 according to an embodiment of the disclosure may execute a training code after transferring data indexes of data batches included in the data subset to the nodes in the computer cluster. When the server 2000 executes the training code, the server 2000 and each of worker nodes may perform training of an AI model stored in each node using a data subset corresponding to each node.

In operation S740, the server 2000 according to an embodiment of the disclosure may obtain training results output for a certain epoch from the nodes in the computer cluster. For example, the server 2000 may obtain a training result of the AI model stored in each of the nodes in the computer cluster whenever an epoch is performed on each of the nodes in the computer cluster one time. For another example, the server 2000 may obtain the training result of the AI model stored in each of the nodes in the computer cluster whenever the epoch is performed on each of the nodes in the computer cluster a plurality of times.

Operations S730 to S740 may correspond to operation S230 of FIG. 2.

In operation S750, the server 2000 according to an embodiment of the disclosure may collect training results of the nodes in the computer cluster to update weights of the AI model stored in the server 2000. The server 2000 may update the weights of the AI model stored in the server 2000, and synchronize the AI models stored in the worker nodes with the AI model stored in the server 2000.

In operation S760, the server 2000 according to an embodiment of the disclosure may identify data throughput and operation speed of the nodes in the computer cluster to change a data batch index value included in the data subset corresponding to each node.

In an embodiment of the disclosure, the server 2000 may calculate an average operation time of the nodes in the computer cluster. The server 2000 may compare the average operation time of the nodes in the computer cluster with each operation time of each of the nodes in the computer cluster. The server 2000 may change the data arrangement index value included in the data subset corresponding to each node, based on results of comparison.

For example, when the operation time of a first worker node is longer than the average operation time of the nodes in the computer cluster, the server 2000 may adjust the number of data batches of a first data subset corresponding to the first worker node to decrease, in order to reduce the operation time of the first worker node. That is, the server 2000 may reduce the data throughput of the first worker node having a slow operation speed, thereby reducing the operation time of the first worker node. For example, when the data batch index included in the first data subset is index numbers 1 to 25, the server 2000 may change the data batch index included in the first data subset to index numbers 1 to 24 so that the first worker node may perform the epoch using the first data subset having the reduced number of data batches. In this case, the server 2000 may adjust the data batch of index number 25 excluded from the first data subset to be included in another data subset (e.g., a data subset corresponding to a node having a high operation speed).

In operation S770, the server 2000 according to an embodiment of the disclosure may execute a next epoch after transferring the updated data batch index of the data subset to the nodes in the computer cluster. When the data batch index included in each of the data subsets is changed, each of the nodes may load training data based on the updated data batch index and train the AI model stored in each of the nodes.

For example, when the data batch index included in the first data subset is changed from index numbers 1 to 25 to index numbers 1 to 24, the first worker node may load training data of index numbers 1 to 24 included in the first data subset, and train the AI model stored in the first worker node.

In an embodiment of the disclosure, a process in which the server 2000 performs distributed learning of the AI model stored in the server 2000 using the server 2000 and the worker nodes may include a preset number of a plurality of epochs. The server 2000 may adjust the number of data batches between training data subsets after performing epochs one or more times. The server 2000 may repeat operations S740 to S770 until the distributed learning process ends. When the server 2000 performs the last epoch when the number of epochs reaches a preset value, operations S760 to S770 may be omitted.

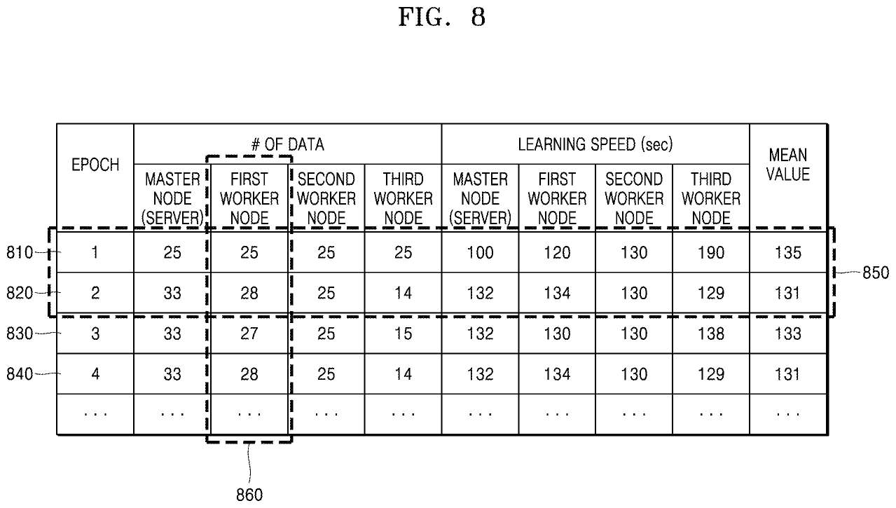

A method, performed by the server 2000, of adjusting the number of data batches between data subsets while performing an epoch that is a part of the distributed learning process will be further described in detail below with reference to FIGS. 8, 9, 10 and 11.

FIG. 8 is a diagram illustrating a method, performed by the server 2000, of adjusting the number of data batches included in each of data subsets according to an embodiment of the disclosure as an epoch which is a part of a distributed learning process is performed.

In FIG. 8, a case in which the nodes in the computer cluster are a total four nodes including the server 2000 that is a master node, a first worker node, a second worker node, and a third worker node will be described as an example. However, the number of nodes in the computer cluster is not limited thereto.

In an embodiment of the disclosure, the server 2000 may execute a training code for performing distributed learning so that the nodes in the computer cluster may train AI models stored in the nodes. The server 2000 may obtain training results from the nodes in the computer cluster. The server 2000 may update weights of the AI model stored in the server 2000 based on training results obtained from the nodes in the computer cluster.

In an embodiment of the disclosure, the nodes in the computer cluster may have different training speeds. The server 2000 may identify an operation time taken for each of the nodes in the computer cluster to perform training, with respect to each of the nodes in the computer cluster. The server 2000 may adjust the number of data batches included in each of the data subsets, based on the operation time of each of the nodes in the computer cluster. For example, after each of the nodes in the computer cluster performs an epoch which is a training process of an AI model stored in each of the nodes, the server 2000 may adjust the number of data batches of the data subset for each of the nodes in the computer cluster to perform a next epoch. The server 2000 may calculate the number of data batches included in the data subset corresponding to the nodes in the computer cluster. In this case, the number of data batches of a data subset corresponding to any node K in the computer cluster may be expressed by Equation 1 below.

$${d\_node}_{k \_ next} = \frac{{d\_node}_{k} \times {t}_{avg}}{{t\_node}_{k}} \times \frac{{D}_{next}}{D} \qquad [ Equation 1 ]$$

Here, d_node_{k_next} denotes the number of data batches to be allocated to the node k when the node k performs the next epoch (the number of next data batches of the data subset corresponding to the node k), d_nodeₖ denotes the number of data batches allocated when the node k performs a current epoch (the number of current data batches of the data subset corresponding to the node k), t_{avg} denotes an average operation time of the nodes in the computer cluster, t_nodeₖ denotes an operation time taken when the node k performs the current epoch, D denotes the total number of training data with respect to the current epoch, and Dₙₑₓₜ denotes the total number of training data with respect to the next epoch.

In an embodiment of the disclosure, the server 2000 may execute a training code so that the server 2000 and worker nodes may perform distributed learning.

In an epoch 1 810, each of the server 2000, a first worker node, a second worker node, and a third worker node may independently train an AI model stored in the node. For example, the server 2000 may train an AI model stored in the server 2000 using a data subset (the number of data batches: 25) of the server 2000, the first worker node may train an AI model stored in the first worker node using a data subset (the number of data batches: 25) of the first worker node, the second worker node may train an AI model stored in the second worker node using a data subset (the number of data batches: 25) of the second worker node, and the third worker node may train an AI model stored in the third worker node using a data subset (the number of data batches: 25) of the third worker node.

The server 2000 may identify the operation time taken for each of the server 2000 and the worker nodes to perform the epoch 1 810. For example, the server 2000 may identify that the operation time taken for the server 2000 to perform the epoch 1 810 is 100 seconds, the operation time taken for the first worker node to perform the epoch 1 810 is 120 seconds, the operation time taken for the second worker node to perform the epoch 1 810 is 130 seconds, and the operation time taken for the third worker node to perform the epoch 1 810 is 190 seconds.

The server 2000 may calculate an average operation time of the nodes in the computer cluster. For example, the server 2000 may calculate that the average operation time taken for the server 2000 and the worker nodes to perform the epoch 1 810 is 135 seconds.

The server 2000 may compare the average operation time of the nodes in the computer cluster with the operation time of each of the nodes in the computer cluster. For example, the server 2000 may identify that the operation time of each of the server 2000, the first worker node, and the second worker node is shorter than the average operation time, and the operation time of the third worker node is longer than the average operation time.

The server 2000 may adjust the number of data batches included in each of the data subsets based on results of comparison. For example, the server 2000 may adjust some data batches of a data subset corresponding to a node with an operation time longer than the average operation time to be included in a data subset corresponding to a node with an operation time shorter than the average operation time. In this case, the server 2000 may compare results of comparison of the average operation time and the operation time of each node with a threshold value, and adjust the number of data batches included in each of the data subsets only when the results of comparison are equal to or greater than the threshold value.

For example, the server 2000 may adjust the number of data batches included in each of the data subsets using Equation 1. The server 2000 may adjust the number of data batches included in the data subset of the server 2000 to 33, the number of data batches included in the data subset of the first worker node to 28, the number of data batches included in the data subset of the second worker node to 25, and the number of data batches included in the data subset of the third worker node to 14.

In an embodiment of the disclosure, when the number of data batches of a training dataset used in the next epoch is changed compared to a current epoch, the server 2000 may apply a ratio of the total data number of the next epoch to the total data number of the current epoch to determine the number of data batches included in the data subset.

In an epoch 2 820, each of the server 2000 and the first worker node, the second worker node, and the third worker node may perform the epoch 2 820 using the data subset having the adjusted number of data batches. The server 2000 may train an AI model stored in the server 2000 using a data subset (the number of data batches: 33) of the server 2000, the first worker node may train an AI model stored in the first worker node using a data subset (the number of data batches: 28) of the first worker node, the second worker node may train an AI model stored in the second worker node using a data subset (the number of data batches: 25) of the second worker node, and the third worker node may train an AI model stored in the third worker node using a data subset (the number of data batches: 14) of the third worker node.

After performing the epoch 2 820, the server 2000 and each of the worker nodes may identify the operation time taken to perform the epoch 2 820. Also, the server 2000 may calculate an average operation time taken for the server 2000 and the worker nodes to perform the epoch 2 820. The server 2000 may compare the average operation time of the nodes in the computer cluster with the operation time of each of the nodes in the computer cluster, and adjust the number of data batches included in each of the data subsets based on results of comparison.

The server 2000 and the worker nodes may perform an epoch 3 830 using the data subsets with the adjusted number of data batches, and adjust the number of data batches included in each of the data subsets according to the above-described embodiments of the disclosure.

After performing the epoch 3 830, the server 2000 may adjust the number of data batches included in each of the data subsets according to the above-described embodiments of the disclosure, and perform an epoch 4 840. The server 2000 may repeat the operation of adjusting the number of data batches included in each of the data subsets and performing the next epoch until the distributed learning process ends.

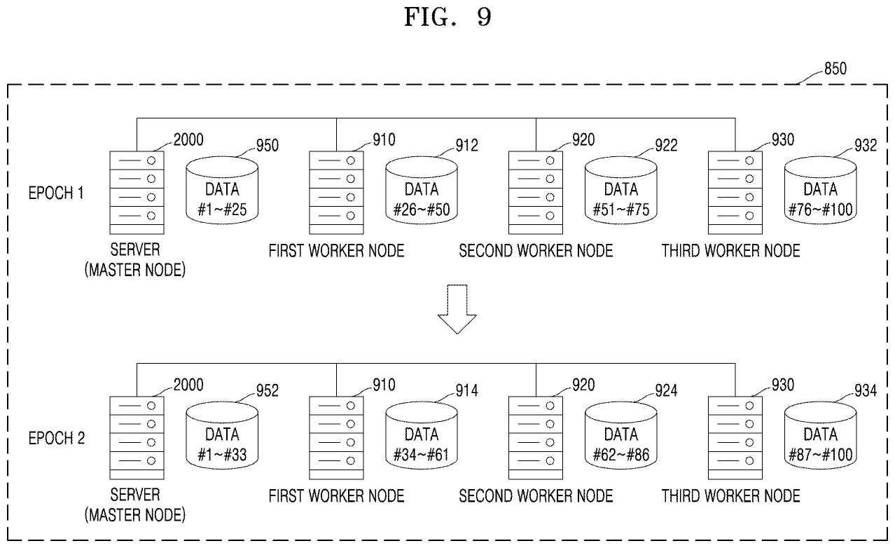

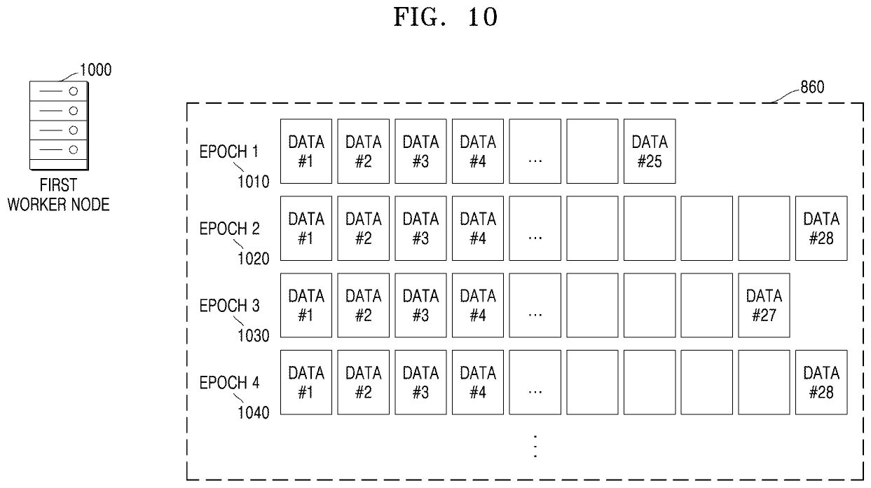

Block 850 representing execution of the epochs 1 810 and 2 820 which are part of the distributed learning process performed by the server 2000 according to an embodiment of the disclosure will be further described with reference to FIG. 9. In addition, block 860 representing execution of the epochs 1 810 to 4 840 by the first worker node when the server 2000 performs distributed learning according to an embodiment of the disclosure will be further described in detail below with reference to FIG. 10.

FIG. 9 is a diagram further illustrating FIG. 8 to illustrate execution of epochs 1 and 2 by nodes in a computer cluster which are part of a distributed learning process.

Referring to FIG. 9, the epochs 1 and 2 of FIG. 9 may correspond to block 850 representing execution of the epochs 1 810 and 2 820 of FIG. 8.

After performing the epoch 1, the server 2000 according to an embodiment of the disclosure may collect results of training AI models stored in the respective nodes from the nodes to update weights of the AI model stored in the server 2000. The server 2000 may update the weights of the AI model stored in the server 2000, and may synchronize AI models stored in worker nodes with the AI model stored in the server 2000.

In an embodiment of the disclosure, a data subset 950 of the server 2000 may include data batches of index numbers 1 to 25. The server 2000 may train the AI model stored in the server 2000, using the data subset 950 of the server 2000. The server 2000 may perform the epoch 1 which performs an operation on all data batches in the data subset 950 of the server 2000.

In an embodiment of the disclosure, a data subset 912 (hereinafter, a first data subset) of a first worker node 910 may include data batches of index numbers 26 to 50. The first worker node 910 may train an AI model stored in the first worker node 910, using the first data subset 912. The first worker node 910 may perform the epoch 1 which performs an operation on all data batches in the first data subset 912.

In an embodiment of the disclosure, a data subset 922 (hereinafter, a second data subset) of a second worker node 920 may include data batches of index numbers 51 to 75. The second worker node 920 may train an AI model stored in the second worker node 920, using the second data subset 922. The second worker node 920 may perform the epoch 1 which performs an operation on all data batches in the second data subset 922.

In an embodiment of the disclosure, a data subset 932 (hereinafter, a third data subset) of a third worker node 930 may include data batches of index numbers 76 to 100. The third worker node 930 may train an AI model stored in the third worker node 930, using the third data subset 932. The third worker node 930 may perform epoch 1, which performs operations on all data batches in the third data subset 932.

After performing the epoch 1, the server 2000 may identify data throughput and operation speed of the respective nodes to change a data batch index value included in a data subset corresponding to each node.

For example, as a result of adjusting a data batch included in data subsets, an updated data subset 952 of the server 2000 may include data batches of index numbers 1 to 33, the updated first data subset 914 may include data batches of index numbers 34 to 61, the updated second data subset 924 may include data batches of index numbers 62 to 86, and the updated third data subset 934 may include data batches of index numbers 87 to 100.

The server 2000 according to an embodiment of the disclosure may allow the server 2000 and the worker nodes to perform the epoch 2 using a data subset having the adjusted number of data batches. In this case, the server 2000 may train the AI model in the server 2000 using the data subset 952 of the updated server 2000. Also, the first worker node 910 may train the AI model in the first worker node 910 using the updated first data subset 914. Also, the second worker node 920 may train an AI model in the second worker node 920 using the updated second data subset 924. Also, the third worker node 930 may train an AI model in the third worker node 930 using the updated third data subset 934.

After performing the epoch 2, the server 2000 may collect results of training the AI model stored in each node from the respective nodes to update the weights of the AI model stored in the server 2000. The server 2000 may update the weights of the AI model stored in the server 2000, and may synchronize the AI models stored in the worker nodes with the AI model stored in the server 2000.

FIG. 10 is a diagram further illustrating FIG. 8 to illustrate execution of epochs 1 1010 to 4 1040 by a first worker node 1000 which is part of a distributed learning process.

Referring to FIG. 10, the epochs 1 1010 to 4 1040 of the first worker node 1000 of FIG. 10 may respectively correspond to block 860 representing execution of the epochs 1 810 to 4 840 by the first worker node of FIG. 8.

In the epoch 1 1010, the first worker node 1000 may perform an operation on data batches of index numbers 1 to 25 included in a data subset of the first worker node 1000. The first worker node 1000 may transmit a result of the epoch 1 1010 training the data batches of index numbers 1 to 25 to the server 2000. The server 2000 may identify an operation speed of the epoch 1 1010 of the first worker node 1000 and adjust the number of data batches included in the data subset of the first worker node 1000 according to the above-described embodiments of the disclosure. For example, as a result of performing the epoch 1 1010, the operation speed of the first worker node 1000 may be faster than an average operation speed of nodes in a computer cluster. In this case, the server 2000 may increase the number of data batches included in the data subset of the first worker node 1000 so that the first worker node 1000 processes more data than other nodes.

In the epoch 2 1020, the first worker node 1000 may perform an operation on data batches of index numbers 1 to 28 included in the data subset of the first worker node 1000. In this regard, the data subset of the first worker node 1000 may be updated based on the result of the epoch 1 1010. The first worker node 1000 may transmit a result of the epoch 2 1020 training the data batches of index numbers 1 to 28 to the server 2000. The server 2000 may identify an operation speed of the epoch 2 1020 of the first worker node 1000 and adjust the number of data batches included in the data subset of the first worker node 1000 according to the above-described embodiments of the disclosure. For example, as a result of performing the epoch 2 1020, the operation speed of the first worker node 1000 may be slower than the average operation speed of the nodes in the computer cluster. In this case, the server 2000 may reduce the number of data batches included in the data subset of the first worker node 1000 so that the first worker node 1000 processes less data than the other nodes.

In the epoch 3 1030, the first worker node 1000 may perform an operation on the data batches of index numbers 1 to 27 included in the data subset of the first worker node 1000. In this regard, the data subset of the first worker node 1000 may be updated based on the result of the epoch 2 1020. The first worker node 1000 may transmit a result of the epoch 3 1030 training the data batches of index numbers 1 to 27 to the server 2000. The server 2000 may identify an operation speed of the epoch 3 1030 of the first worker node 1000 and adjust the number of data batches included in the data subset of the first worker node 1000 according to the above-described embodiments of the disclosure.

In the epoch 4 1040, the first worker node 1000 may perform an operation on the data batches of index numbers 1 to 27, included in the data subset of the first worker node 1000 updated based on the result of the epoch 3 1030. The first worker node 1000 may transmit a result of the epoch 4 1040 training the data batches of index numbers 1 to 27 to the server 2000. The server 2000 may identify an operation speed of the epoch 4 1040 of the first worker node 1000 and adjust the number of data batches included in the data subset of the first worker node 1000 according to the above-described embodiments of the disclosure.

In an embodiment of the disclosure, the data batch included in the data subset and distinguished by the index number may include a plurality of pieces of training data as described above. For example, when the batch size is 10, the data batch of index number 1 may include 10 training data. When performing distributed learning using nodes in a cluster, the server 2000 may adjust the number of data batches while maintaining a batch size set for each of the nodes in the cluster, thereby equalizing operation speed between the nodes and increasing the speed of distributed learning.

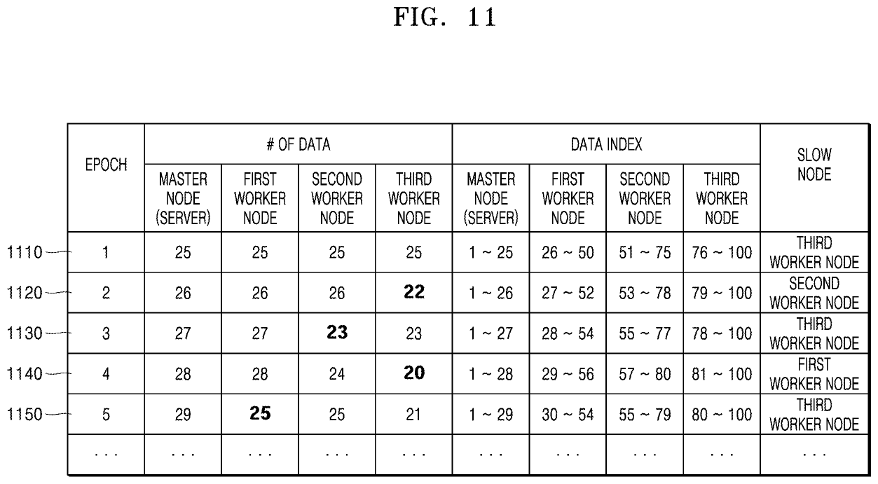

FIG. 11 is a diagram illustrating another method, performed by the server 2000, of adjusting the number of data batches included in each of data subsets according to an embodiment of the disclosure as an epoch which is a part of a distributed learning process is performed.

In an embodiment of the disclosure, the server 2000 may identify a node with the longest operation time among nodes in a computer cluster. The server 2000 may adjust some data of a data subset corresponding to the node with the longest operation time to be included in data subsets corresponding to the other nodes in the computer cluster.

In an embodiment of the disclosure, the server 2000 may execute a training code so that the server 2000 and worker nodes perform distributed learning.

In an epoch 1 1110, the server 2000, a first worker node, a second worker node, and a third worker node may each independently train an AI model stored in the node. For example, when the epoch 1 1110 is performed, the server 2000 may train an AI model stored in the server 2000 using a data subset (the number of data batches: 25) of the server 2000, the first worker node may train an AI model stored in the first worker node using a data subset (the number of data batches: 25) of the first worker node, the second worker node may train an AI model stored in the second worker node using a data subset (the number of data batches: 25) of the second worker node, and the third worker node may train an AI model stored in the third worker node using a data subset (the number of data batches: 25) of the third worker node.

The server 2000 may identify an operation time taken for each of the server 2000 and the first to third worker nodes to perform the epoch 1 1110, and identify a node having the longest operation time. For example, as a result of performing the epoch 1 1110, the server 2000 may identify the third worker node having the longest operation time. The server 2000 may adjust some of data batches included in a data subset of the third worker node with the longest operation time to be included in the data subsets of the first and second worker nodes.

For example, the server 2000 may reduce the number of data included in the data subset of the third worker node to 22, increase the number of data batches included in the data subset of the server 2000 to 26, increase the number of data batches included in the data subset of the first worker node to 26, and increase the number of data batches included in the data subset of the second worker node to 26.

In this case, the server 2000 may change a data batch index value included in the data subset corresponding to each of the first to third worker nodes, thereby adjusting the number of data batches. For example, the server 2000 may allow the data subset of the server 2000 to include data batches of index numbers 1 to 26, the data subset of the first worker node to include data batches of index numbers 27 to 52, the data subset of the second worker node to include data batches of index numbers 53 to 78, and the data subset of the third worker node to include data batches of index numbers 79 to 100.

The server 2000 according to an embodiment of the disclosure may allow the server 2000 and the worker nodes to perform an epoch 2 1120 using a data subset having the adjusted number of data batches.

For example, when the epoch 2 1120 is performed, the server 2000 may train an AI model stored in the server 2000 using the updated data subset (the number of data batches: 26) of the server 2000, the first worker node may train an AI model stored in the first worker node using the data subset (the number of data batches: 26) of the updated first worker node, the second worker node may train an AI model stored in the second worker node using the data subset (number of data batches: 26) of the updated second worker node, and the third worker node may train an AI model stored in the third worker node using the data subset (number of data batches: 22) of the updated third worker node.

The server 2000 according to an embodiment of the disclosure may identify a worker node with the longest operation time whenever an epoch is performed using the above-described methods. The server 2000 may adjust some data of the data subset corresponding to the worker node with the longest operation time to be included in the data subsets corresponding to the another worker nodes in the computer cluster whenever an epoch is performed, thereby performing an epoch 3 1130, an epoch 4 1140, and an epoch 5 1150.

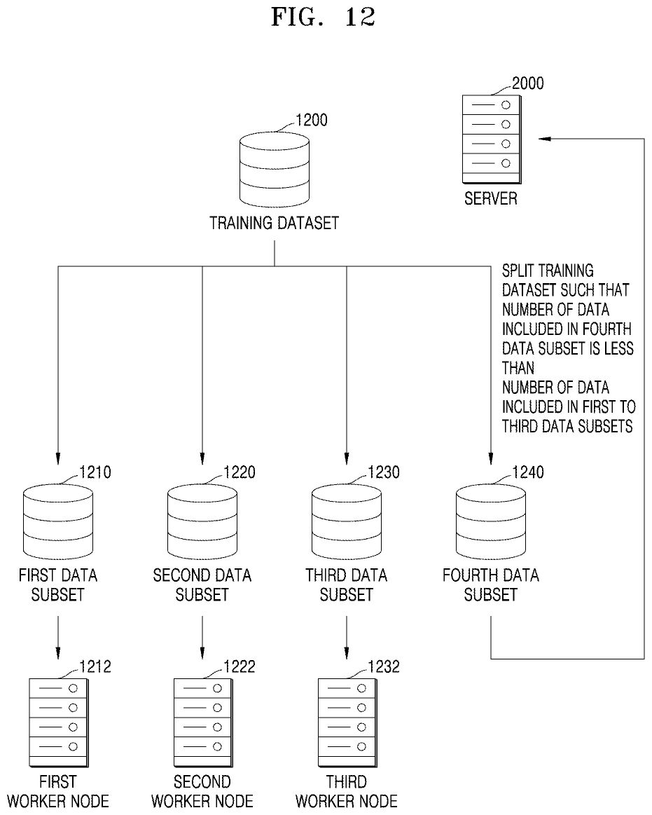

FIG. 12 is a diagram illustrating another method, performed by the server 2000, of splitting a training data set 1200 and determining data subsets according to an embodiment of the disclosure.

In an embodiment of the disclosure, because the server 2000 serves as a master node of a computer cluster, in addition to training an AI model stored in the server 2000, the server 2000 may perform other works for managing worker nodes included in the computer cluster. Accordingly, the server 2000 may allocate less number of data of the data subset corresponding to the server 2000.

In an embodiment of the disclosure, the server 2000 may split the training dataset 1200 to generate data subsets corresponding to the number of nodes in the computer cluster. For example, the server 2000 may split the training dataset 1200 to generate a first data subset 1210, a second data subset 1220, a third data subset 1230, and a fourth data subset 1240. Each of the first to fourth data subsets 1210, 1220, 1230, and 1240 may correspond to each of the nodes in the computer cluster. For example, the first data subset 1210 may correspond to a first worker node 1212, the second data subset 1220 may correspond to a second worker node 1222, the third data subset 1230 may correspond to the third worker node 1232, and the fourth data subset 1240 may correspond to the server 2000.

The server 2000 according to an embodiment of the disclosure may split the training dataset 1200 such that the number of data batches included in the fourth data subset 1240 is less than the number of data batches included in the first to third data subsets 1210, 1220, and 1230. Specific methods, performed by the server 2000, of splitting the training dataset 1200 and generating data subsets have been described above, and thus the same descriptions may not be repeated.

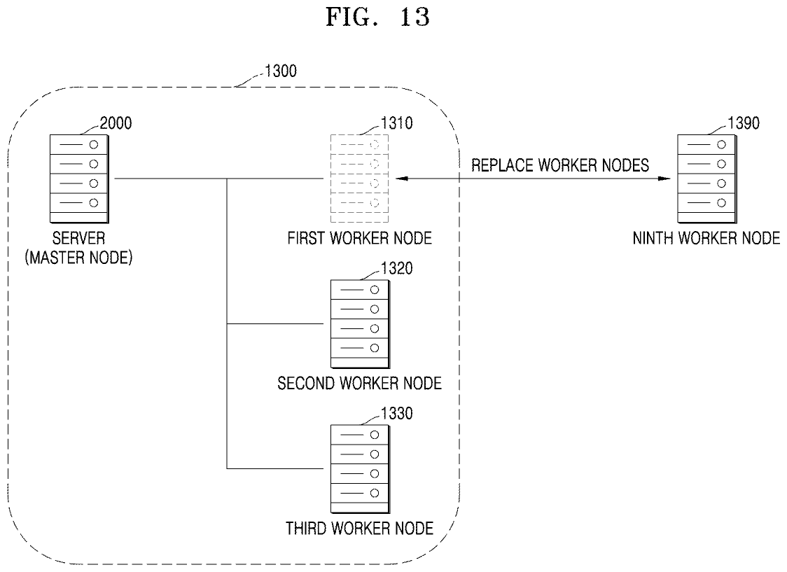

FIG. 13 is a flowchart illustrating another method, performed by the server 2000, of operating a computer cluster 1300 and performing distributed learning according to an embodiment of the disclosure.

In FIG. 13, a case where nodes in the computer cluster 1300 are a total of four nodes including the server 2000 that is a master node, a first worker node 1310, a second worker node 1320, and a third worker node 1330 will be described as an example. However, the number of nodes in the computer cluster 1300 is not limited thereto.

The server 2000 according to an embodiment of the disclosure may identify the operation speed of nodes in the computer cluster 1300. The server 2000 may select one or more worker nodes from among the nodes in the computer cluster 1300 based on an operation time of each of the nodes in the computer cluster 1300.

For example, the server 2000 may select a node with the longest operation time from among the nodes in the computer cluster 1300. For example, when the operation time of the first worker node 1310 is the longest, the server 2000 may select the first worker node 1310 which is the node having the longest operation time.

The server 2000 according to an embodiment of the disclosure may remove selected one or more worker nodes from the computer cluster 1300 and incorporate one or more other nodes into the computer cluster 1300 as worker nodes. The server 2000 may select an available node from a list of available nodes as a worker node to be incorporated into the computer cluster 1300. For example, the server 2000 may select a ninth worker node 1390 that is another available node from the list of available nodes and incorporate the ninth worker node 1390 into the computer cluster 1300.

Each time an epoch that is a part of a distributed learning process is performed a certain number of times (e.g., once or twice) or more, the server 2000 according to an embodiment of the disclosure may select one or more worker nodes from among the nodes in the computer cluster 1300. The server 2000 may exclude the selected one or more worker nodes from the computer cluster 1300, and may incorporate one or more other available nodes into the computer cluster 1300 as worker nodes.

In the disclosed embodiments of the disclosure, when the server 2000 performs distributed learning using a computer cluster, the server 2000 may increase the speed of distributed learning while adjusting the number of data of a data subset or replacing worker nodes. Each time the epoch of the distributed learning process is performed the certain number of times, the server 2000 may perform distributed learning by adjusting the number of data of the data subset, replacing worker nodes, or combining the adjustment of the number of data of the data subset and replacement of the worker nodes.

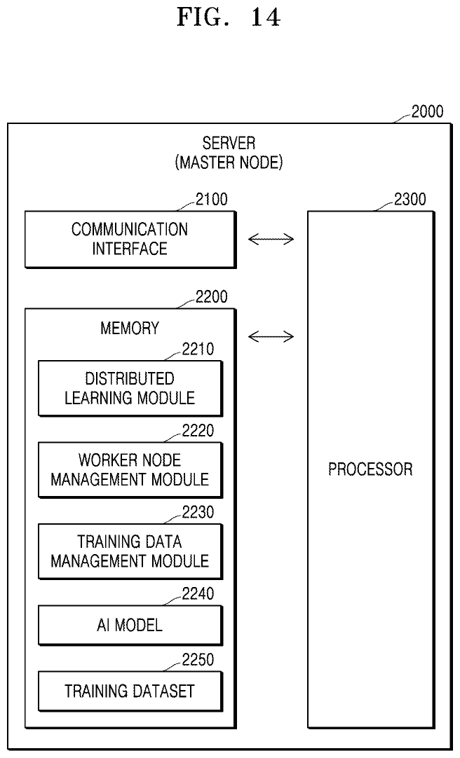

FIG. 14 is a block diagram illustrating a configuration of the server 2000 according to an embodiment of the disclosure.

Referring to FIG. 14, the server 2000 according to an embodiment of the disclosure may include a communication interface (e.g., including communication circuitry) 2100, a memory 2200, and a processor (e.g., including processing circuitry) 2300.

The communication interface 2100 may include various communication circuitry and perform data communication with other nodes of a computer cluster under the control by the processor 2300. Also, the communication interface 2100 may perform data communication with other peripheral electronic devices as well as other nodes of the computer cluster.

The communication interface 2100 may perform data communication with other nodes of the computer cluster or other peripheral electronic devices using at least one of, for example, wired LAN, wireless LAN, Wi-Fi, Bluetooth, Zigbee, WFD (Wi-Fi Direct), infrared communication (IrDA, Infrared Data Association), BLE (Bluetooth Low Energy), NFC (Near Field Communication), WiBro (Wireless Broadband Internet, Wibro), WiMAX (World Interoperability for Microwave Access, WiMAX), SWAP (Shared Wireless Access Protocol), WiGig (Wireless Gigabit Alliance) or a data communication method including RF communication.

The communication interface 2100 according to an embodiment of the disclosure may transmit a command for performing distributed learning to the nodes in the computer cluster and receive distributed learning results from the nodes in the computer cluster. The communication interface 2100 may transmit data for synchronizing an AI model stored in each of the nodes in the computer cluster to each of the nodes in the computer cluster.

The memory 2200 may store instructions, data structures, and program codes that the processor 2300 may read. In the disclosed embodiments of the disclosure, operations performed by the processor 2300 may be implemented by executing instructions or codes of a program stored in the memory 2200.

The memory 2200 may include flash memory type memory, hard disk type memory, multimedia card micro type memory, card type memory (e.g., SD or XD memory), random access memory (RAM), non-volatile memory including at least one of static random access memory (SRAM), read-only memory (ROM), electrically erasable programmable read-only memory (EEPROM), programmable read-only memory (PROM), magnetic memory, magnetic disk, or an optical disk, and volatile memory such as RAM or SRAM.

The memory 2200 according to an embodiment of the disclosure may store various types of data that may be used by the computer cluster to perform distributed learning. For example, a distributed learning module 2210, a worker node management module 2220, a training data management module 2230, an AI model 2240, and a training dataset 2250 may be stored in the memory 2200. Each of these modules may include various processing circuitry and/or executable program instructions.

The processor 2300 may include various processing circuitry and control overall operations of the server 2000. For example, the processor 2300 may execute one or more instructions of a program stored in the memory 2200, thereby controlling the overall operation for the server 2000 to perform distributed learning using the computer cluster.

The processor 2300 may include at least one of, for example, a central processing unit, a microprocessor, a graphics processing unit, application specific integrated circuits (ASICs), digital signal processors (DSPs), digital signal processing devices (DSPDs), programmable logic devices (PLDs), field programmable gate arrays (FPGAs), application processor (AP), neural processing unit, or an AI dedicated processor designed in a hardware structure specialized for processing an AI model, but is not limited thereto.

In an embodiment of the disclosure, the processor 2300 may train the AI model 2240 using the distributed learning module 2210. The distributed learning module 2210 may execute a training code for distributed learning, so that nodes in the computer cluster may independently perform training. In this case, the distributed learning module 2210 may copy the AI model 2240 to generate replicated AI models, in order for the nodes in the computer cluster to independently perform training. The distributed learning module 2210 may obtain training results resulting from training the replicated AI models stored in the nodes, from the nodes in the computer cluster, and update weights of the AI model 2240. The distributed learning module 2210 may synchronize the replicated AI models stored in the nodes in the computer cluster with the AI model 2240.

In an embodiment of the disclosure, the processor 2300 may manage the worker nodes in the computer cluster using the worker node management module 2220. The worker node management module 2220 may identify nodes available for distributed learning among a plurality of nodes. An available node may be an idle node that is not performing another work, or a node with free computing resources capable of performing distributed learning. The worker node management module 2220 may select worker nodes that are to perform distributed learning from among the available nodes to build the computer cluster. The worker node management module 2220 may identify the available nodes and generate a list of the available nodes. The worker node management module 2220 may identify an available node again according to whether each of the plurality of nodes is performing a work, and update the list of available nodes. The worker node management module 2220 may identify an operation time taken for the worker node to train the AI model stored in the worker node. The worker node management module 2220 may remove at least some of the worker nodes in the computer cluster from the computer cluster, based on a result of identifying operation time of the worker nodes in the computer cluster, and incorporate at least some of the available nodes into the computer cluster as worker nodes, thereby rebuilding the computer cluster.

In an embodiment of the disclosure, the processor 2300 may manage the training data using the training data management module 2230. The training data management module 2230 may split the training dataset 2250 for training the AI model to determine a plurality of data subsets. The training data management module 2230 may split the training dataset 2250 to determine the number of data subsets to be generated, based on the number of nodes in the computer cluster. Specifically, the training data management module 2230 may generate data subsets as many as the number of nodes in the computer cluster. In this case, each of the data subsets may correspond to each of the nodes in the computer cluster. The training data management module 2230 may index training data in the training dataset 2250 and determine an index number to be included in each of data subsets, thereby generating the data subsets. In addition, the training data management module 2230 may change a data batch index value included in the data subset corresponding to each node, in order to adjust the number of data included in the data subset corresponding to each of the worker nodes.

The block diagram of the server 2000 shown in FIG. 14 is a block diagram illustrating an example embodiment of the disclosure. The elements of the block diagram may be integrated, an element may be added, or an element may be omitted according to the specification of each device that is actually implemented. In other words, two or more elements may be integrated into one element or one element may be divided into two or more elements when necessary. A function performed by each block is only for describing example embodiments of the disclosure and specific operations or apparatuses do not limit the scope of the disclosure.

An operating method of a server, according to an embodiment of the disclosure, may be recorded on a non-transitory computer-readable recording medium by being implemented in a form of program commands executed using various computers. The non-transitory computer-readable recording medium may include at least one of a program command, a data file, or a data structure. The program commands recorded in the computer-readable recording medium may be specially designed or well known to one of ordinary skill in the computer software field. Examples of the computer-readable recording medium include magnetic media such as hard disks, floppy disks, and magnetic tapes, optical media such as CD-ROMs and DVDs, magneto-optical media such as floptical disks, and hardware devices specially configured to store and perform program commands, such as read-only memory (ROM), random-access memory (RAM), and flash memory. Examples of the computer command include machine codes generated by a compiler, and high-level language codes executable by a computer using an interpreter. The computer-readable storage medium may be provided in the form of a non-transitory storage medium. Herein, the “non-transitory” storage medium is a tangible device, and may not include a signal (e.g., an electromagnetic wave), but this term does not differentiate between where data is semi-permanently stored in the storage medium and where the data is temporarily stored in the storage medium. For example, the ‘non-transitory storage medium’ may include a buffer in which data is temporarily stored.

Furthermore, an operating method of a server, according to the embodiments of the disclosure may be provided by being included in a computer program product. The computer program products are products that may be traded between sellers and buyers.

The computer program product may include a software program or a computer-readable storage medium storing a software program. For example, the computer program product may include a product (for example, a downloadable application) in a form of a software program that is electronically distributable through a manufacturer of the electronic device or an electronic market. For electronic distribution, at least a part of the software program may be stored in the storage medium or temporarily generated. In this case, the storage medium may be a storage medium of a server of a manufacturer, a server of an electronic market, or a relay server that temporarily stores the software program.

The computer program product may include a storage medium of a server or a storage medium of a client apparatus in a system including the server and the electronic device. When there is a third device, e.g., a smartphone that communicates with the server or the electronic device, the computer program product may include a storage medium of the third device. Alternatively, the computer program product may include the software program transmitted from the server to the electronic device or the third device, or transmitted from the third device to the electronic device.

In this case, one of the server, the electronic device, and the third device may perform a method according to embodiments of the disclosure by executing the computer program product. Two or more of the server, the electronic device, and the third device may execute the computer program product to perform the method according to the embodiments of the disclosure in a distributed fashion.

For example, the server may execute the computer program product stored in the server, and may control the e device communicating with the server to perform a method according to disclosed embodiments of the disclosure.

While the disclosure has been illustrated and described with reference to various example embodiments, it will be understood that the various example embodiments are intended to be illustrative, not limiting. It will be further understood by those of ordinary skill in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method, performed by a server, of performing distributed learning, the method comprising:
building a computer cluster by selecting worker nodes configured to perform distributed learning, from among a plurality of nodes, wherein nodes in the computer cluster comprise the server that is a master node and the worker nodes;
determining data subsets by splitting a training dataset wherein each of the data subsets corresponds to each of the nodes in the computer cluster;
obtaining training results from the nodes in the computer cluster by training each artificial intelligence (AI) model stored in each of the nodes in the computer cluster based on each of the data subsets;
updating weights of an AI model stored in the server based on the training results;
identifying, with respect to each of the nodes in the computer cluster, an operation time taken for each of the nodes in the computer cluster to perform training; and
adjusting a number of data included in each of the data subsets, based on the operation time of each of the nodes in the computer cluster.

2. The method of claim 1, wherein the obtaining of the training results from the nodes in the computer cluster comprises:
obtaining, from the first worker node, a first training result generated based on a first worker node among the worker nodes training an AI model stored in the first worker node using a first data subset corresponding to the first worker node; and
obtaining, from the second worker node, a second training result generated based on a second worker node from among the worker nodes training an AI model stored in the second worker node using a second data subset corresponding to the second worker node.

3. The method of claim 1, further comprising performing next training for each AI model stored in each of the nodes in the computer cluster using each of the nodes in the computer cluster, wherein the nodes in the computer cluster perform the next training using the data subsets in which the number of data is adjusted.

4. The method of claim 3, wherein, based on the nodes in the computer cluster performing the next training, a batch size set for each of the nodes in the computer cluster is maintained.

5. The method of claim 1, further comprising determining an average operation time of the nodes in the computer cluster,
wherein the adjusting of the number of data included in each of the data subsets comprises:
comparing an average operation time of the nodes in the computer cluster with the operation time of each of the nodes in the computer cluster; and
adjusting the number of data included in each of the data subsets based on a result of the comparing.

6. The method of claim 5, wherein the adjusting of the number of data included in each of the data subsets based on the comparing comprises adjusting the number of data included in each of the data subsets based on the result of the comparing being greater than or equal to or a threshold value.

7. The method of claim 4, wherein the adjusting of the number of data included in each of the data subsets comprises adjusting some data of a data subset corresponding to a node with an operation time longer than the average operation time to be included in a data subset corresponding to a node with an operation time shorter than the average operation time.

8. The method of claim 1, wherein the determining of the data subsets comprises splitting the training dataset wherein a number of data in a data subset corresponding to the master node is less than a number of data in each of the data subsets corresponding to the worker nodes.

9. The method of claim 1, wherein the adjusting of the number of data included in each of the data subsets comprises adjusting some data of a data subset corresponding to a node having a longest operation time among the nodes in the computer cluster to be included in the data subsets corresponding to the other nodes in the computer cluster.

10. The method of claim 1, further comprising:
selecting one or more worker nodes from among the nodes in the computer cluster, based on the operation time of each of the nodes in the computer cluster; and
removing the selected one or more worker nodes from the computer cluster and incorporating one or more other nodes into the computer cluster as worker nodes.

11. A server for performing distributed learning, the server comprising:
a communication interface comprising communication circuitry;
a memory storing one or more instructions;
at least one processor configured to execute the one or more instructions stored in the memory; and
the at least one processor is further configured based on executing the one or more instructions to:
build a computer cluster by selecting worker nodes configured to perform distributed learning from among a plurality of nodes, wherein nodes in the computer cluster comprise the server that is a master node and the worker nodes;
determine data subsets by splitting a training dataset wherein each of the data subsets corresponds to each of the nodes in the computer cluster;
obtain training results from the nodes in the computer cluster by training each artificial intelligence (AI) model stored in each of the nodes in the computer cluster based on each of the data subsets;
update weights of an AI model stored in the server based on the training results;
identify, with respect to each of the nodes in the computer cluster, an operation time taken for each of the nodes in the computer cluster to perform training; and
adjust a number of data included in each of the data subsets, based on the operation time of each of the nodes in the computer cluster.

12. The server of claim 11, wherein the at least one processor is further configured by executing the one or more instructions to:
obtain, from the first worker node, a first training result generated based on a first worker node from among the worker nodes training an AI model stored in the first worker node using a first data subset corresponding to the first worker node; and
obtain, from the second worker node, a second training result generated based on a second worker node from among the worker nodes training an AI model stored in the second worker node using a second data subset corresponding to the second worker node.

13. The server of claim 11, wherein the at least one processor is further configured by executing the one or more instructions to perform next training for each AI model stored in each of the nodes in the computer cluster using each of the nodes in the computer cluster, wherein the nodes in the computer cluster perform the next training using the data subsets in which the number of data is adjusted.

14. The server of claim 13, wherein, based on the nodes in the computer cluster perform the next training, a batch size set for each of the nodes in the computer cluster is maintained.

15. The server of claim 11, wherein the at least one processor is further configured by executing the one or more instructions to:
determine an average operation time of the nodes in the computer cluster;
compare an average operation time of the nodes in the computer cluster with the operation time of each of the nodes in the computer cluster; and
adjust the number of data included in each of the data subsets based on a result of the comparing.

16. The server of claim 14, wherein the at least one processor is further configured by executing the one or more instructions to adjust some data of a data subset corresponding to a node with an operation time longer than the average operation time to be included in a data subset corresponding to a node with an operation time shorter than the average operation time.

17. The server of claim 11, wherein the at least one processor is further configured by executing the one or more instructions to split the training dataset wherein a number of data in a data subset corresponding to the master node is less than a number of data in each of the data subsets corresponding to the worker nodes.

18. The server of claim 11, wherein the at least one processor is further configured by executing the one or more instructions to adjust some data of a data subset corresponding to a node with a longest operation time from among the nodes in the computer cluster to be included in the data subsets corresponding to the other nodes in the computer cluster.

19. The server of claim 11, wherein the at least one processor is further configured by executing the one or more instructions to:
select one or more worker nodes from among the nodes in the computer cluster, based on the operation time of each of the nodes in the computer cluster; and
remove the selected one or more worker nodes from the computer cluster and incorporate one or more other nodes into the computer cluster as worker nodes.

20. A non-transitory computer-readable recording medium having recorded thereon a program for executing, on a computer, the method of claim 1.
